(19) United States
(12) Patent Application Publication
(10) Pub. No.: US 2012/0266510 A1
(43) Pub. Date: Oct. 25, 2012

(54) Flat spring sign stand

(76) Inventors: James G. Kokenes, West mont, IL (US); Vera D. Dicke, Downers Grove, IL (US)

(21) Appl. No.: 13/066,735

(22) Filed: Apr. 22, 2011

(51) Int. Cl. G09F 15/00

(52) U.S. Cl. 40/610

(57) ABSTRACT

A flat spring deflectable sign stand assembly principally intended for portable, temporary roadside signs. The flat steel spring allows for improved deflection strength to withstand forces caused by air turbulence from weather conditions and passing vehicles. The quick-release collapsible leg assembly allows for easy storage and on-site assembly of the stand. Telescopic legs allow for proper positioning and stability of the stand under varying roadside conditions.

### FIELD OF THE INVENTION

The present invention relates generally to the field of resiliently deflectable sign stand assemblies capable of receiving an upright mast. More particularly, the present invention pertains to such sign stand assemblies of improved strength used for holding masts with sign panels displaying traffic warnings or providing notice that a worksite has been established in a particular area, capable of quick deployment and removal, yet collapsing into a compact package for storage and transport.

### BACKGROUND OF THE INVENTION

Signs providing warnings and other information are often needed alongside paths of traffic, whether vehicular or pedestrian. Message panels conveying a suitable warning or other notice must be of substantial size in order to attract attention. It has been observed, when such signs are located out of doors, that forces developed by wind gusts and air turbulence caused by nearby vehicles is substantial. Accordingly, it has been recognized that, by providing a resilient deflectable mounting located at the base of the sign panel it will be able to absorb at least a portion of the wind energy imparted against the surface of the sign panel, preventing overturning of the sign panel.

Various structures have been devised to accommodate temporary deflection of signs, posters, and the like. For example, French Patent No. 1,181,967 discloses an upright sign post supported by a pair of resilient foldable base members. Resilient support for a poster board is shown in U.S. Pat. No. 3,662,482, and an adjustable flexible mast is shown in U.S. Pat. No. 4,309,836. In addition, deflectable mountings are shown in commonly assigned U.S. Pat. Nos. 4,863,138; 4,865,288; and 4,886,232. Although these and other arrangements have met with commercial success, improvements are continually being sought. For example, there is an increasingly popular use of folding warning devices which are compact so as to be stored in the trunk of a passenger vehicle, or otherwise made to fit in a relatively small space. Warning devices of these types are typically employed only for brief periods of time, and the occasion of their deployment oftentimes cannot be predicted in advance. For example, emergency personnel working near a roadway can benefit from traffic warning signs alerting motorists to expect a nearby emergency scene. Accordingly, it is important that warning signs be quickly and easily erected without requiring tools or special knowledge. Commonly assigned U.S. Pat. No. 7,686,264 depicts a quick-release mechanism suitable for this purpose and is hereby incorporated by reference into the present application in its entirety. Commonly assigned U.S. Pat. No. 6,186,463 depicts a releasable coupling assembly suitable for quickly erecting and removing the sign panel and is hereby incorporated by reference into the present application in its entirety. Further, it is becoming increasingly important that such warning devices be made of light weight, low maintenance, especially non-corrosive materials.

One device that addresses some of the aforementioned concerns is U.S. Pat. No. 5,851,001, entitled “Deflectable Mounting for Upright Mast.” U.S. Pat. No. 5,851,001 is hereby incorporated by reference into the present application in its entirety.

Still, improvements to the materials, releasable coupling assembly, and support base assembly are possible. Accordingly, it is a general object of the present invention to provide an improved deflectable sign stand assembly for warning signs.

### SUMMARY OF THE INVENTION

The present invention is directed to a deflectable sign stand assembly capable of holding an upright mast to be used in displaying traffic or other roadside warnings.

It is an object of the present invention to provide a sign stand assembly with a support base which can be collapsed into a compact package for storage.

A deflectable sign stand assembly according to the present invention includes a flat steel spring for superior strength and durability in order to withstand the forces imposed by wind gusts.

These and other objects according to principles of the present invention are provided in a resilient support assembly capable of supporting a mast which carries a message panel and which has a lower end extending below the message panel, a preferred embodiment of the deflectable support assembly comprising:

releasable coupling assembly;

a flat steel spring;

a support base; and

hollow, telescoping legs pivotably mounted to the support base and equipped with a quick-release mechanism for easy set-up and removal.

These and other features and advantages of the present invention will be understood upon consideration of the following detailed description of the invention and the accompanying drawings.

### BRIEF DESCRIPTION OF THE DRAWINGS

FIG. 1 is an exploded perspective view of the sign stand assembly.

FIG. 2 is a side elevation, shown partly broken away, of a releasable coupling assembly according to the principles of the present invention.

FIG. 3 is a cross-sectional view taken along the line 3-3 of FIG. 2.

FIG. 4 is a cross-sectional view taken along the line 4-4 of FIG. 2.

FIG. 5 is a fragmentary cross-sectional view of the quick-release mechanism;

FIG. 6 is a cross-sectional view similar to that of FIG. 5 but showing the actuator in a different stage of operation; and

FIG. 7 is a top plan view of a leaf spring shown in FIGS. 5 and 6.

### DESCRIPTION OF THE PREFERRED EMBODIMENTS

The present invention is directed to a portable, temporary stand for display of roadside signs. Use of a spring in the mounting mechanism between the mast and base allows for deflection of the sign panel in response to wind gusts due to air turbulence from passing vehicles or weather conditions. In the preferred embodiment the spring is a flat steel spring for improved strength and durability.

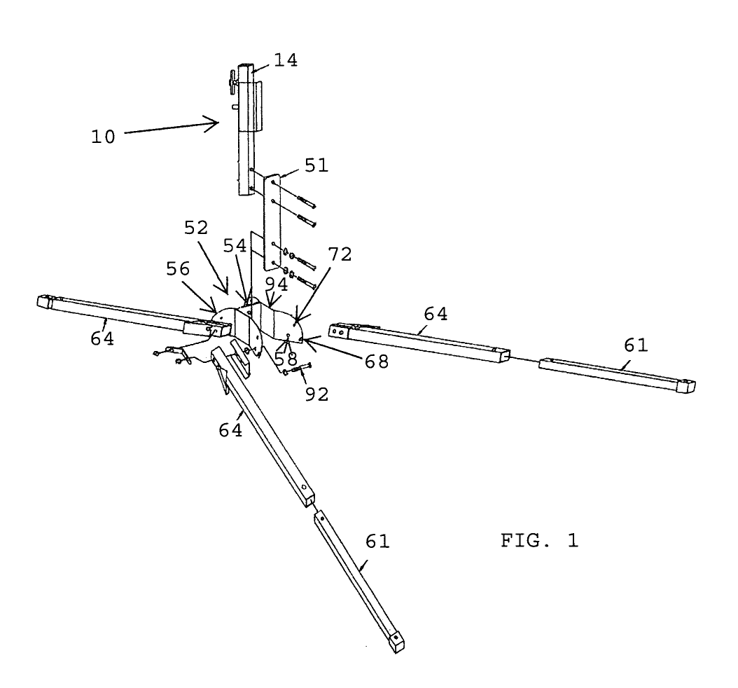

Referring to FIG. 1, in accordance with a preferred embodiment of the present invention, an exploded perspective view of the sign stand assembly is shown. The sign stand assembly includes a releasable coupling assembly 10 mounted to a flat steel spring 51 which is in turn mounted to a support base 52. At least one leg 64 is mounted to the support base 52, each leg preferably hollow and can be dimensioned to telescopically receive a smaller dimensioned tubular leg 61 capable of extending the length of the leg portion.

With reference to FIG. 1, spring 51 is supported by a support base assembly 52 including an L-shaped vertical mounting piece 54 supported between side plates 94. Side plates 94 include ear portions 56 having holes 58 to receive a bolt fastener 92 which provides pivot support for ground engaging legs 64. Ears 56 further include holes 68 which define an extended or operational configuration of the legs. Ear portions 56 also include holes 72 which define a collapsed storage position for the legs 64.

Referring now to FIGS. 2-4, a releasable coupling assembly is generally indicated at 10. The coupling assembly 10 is shown for use with an upright mast 12 of the type which supports flexible sign panels, such as those employed at roadside locations to provide advance warning of nearby work site activity. As will be appreciated from studying the coupling assembly described herein, mast 12 could be replaced with any number of elongated structural members, such as wooden slats, aluminum tubing, or lengths of structural steel having a variety of cross sections. Further, the coupling assembly described herein could also be readily employed with members having a circular cross section. Coupling assembly 10 includes a body 14, preferably in the form of a hollow tubular member having a square cross-section. Body 14 has opposed forward and rearward walls 16, 18 and sidewalls 20, 22. As can be seen in FIG. 2, for example, there are a number of cooperating components located internal as well as external to body 14. In the preferred embodiment, body 14 is formed of conventional tubular steel, although a number of other materials and cross-sectional shapes could be used for body 14. When employed as a roadside warning system, it has been found helpful to enclose moving components, shielding them from salt, dirt and other contamination which may be stirred up by traffic passing the work site. In the preferred embodiment, body 14 is made hollow so as to enclose working components to be described herein.

As can be seen in FIG. 2, mast 12 is nested within a mounting channel 28 having end walls 30, 32 and an intermediate wall 34 against which a major face 12a of the mast is pressed. In the preferred embodiment, the sidewall 32 is secured to sidewall 20 of body 14 using conventional fastening means, preferably a welded joinder. In the preferred embodiment, body 14 is secured to a ground engaging base (not shown) so as to assume a self-standing upright position. The present invention also contemplates a coupling between a body member, such as the square tubing 14 shown in FIG. 2 and an elongated member such as the mast 12 shown in the same figure. Other uses for the coupling assembly are possible. For example, sign stand assemblies are sometimes provided with adapters so that one type of ground support can be engaged with different types of upright sign supports. For example, the mast 12 could extend below body member 14 to a ground-engaging support, with a coupling assembly 10 providing a convenient transition to a rigid tubular upright system. As mentioned, body 14 is preferably hollow and can be dimensioned to telescopically receive a slightly smaller tubing functioning as an upright support, such as a vertical sign panel support member, In another alternative, mast 12 could comprise a spring member extending above a ground-engaging base. A mast-shaped spring member could be made of conventional metal or non-metallic laminate constructions, for example. Such elongated spring members would be less expensive and weigh less than sets of conventional coil springs which are found in many existing sign stand assemblies.

Releasable coupling assembly 10 provides a carefully defined engagement with mast 12. For example, engagement systems could be provided which encircle mast 12 with a girdling constriction. As a further possibility, a pair of opposed jaws could be made to engage opposed faces of mast 12 with both jaws being drawn toward one another, so as to pinch the mast therebetween. The preferred embodiment of the present invention employs a different type of engagement where the mast is compressed between a stationary support surface (herein the intermediate channel wall 34) and a movable press plate 40 having a pressing surface 40a disposed generally parallel to the intermediate channel wall 34. This type of arrangement has been found to provide substantial advantages in at least two different respects. First, it has been found important to control the surface abrasion which results when clamping forces are applied to masts. The coupling assembly of the present invention also provides improved protection of the mast while allowing the performance needed under conditions which cause mast 12 to vibrate. It has been found important to provide a continuous stationary support for one face of mast 12. By continuously supporting a major face of the mast with a stationary support surface or wall, a maximum protection against deterioration of the mast surface contacting the support wall is provided. It is important that the clamping pressure applied to the face of the mast opposite the support wall is adequate to support the coupling engagement against static as well as vibrational forces, such as those associated with gusting wind conditions. The clamping pressure should not be so great, however, that the exposed mast face is subjected to forces by members which might intrude into the matrix of mast 12 or otherwise cause the mechanical integrity of the mast to degrade.

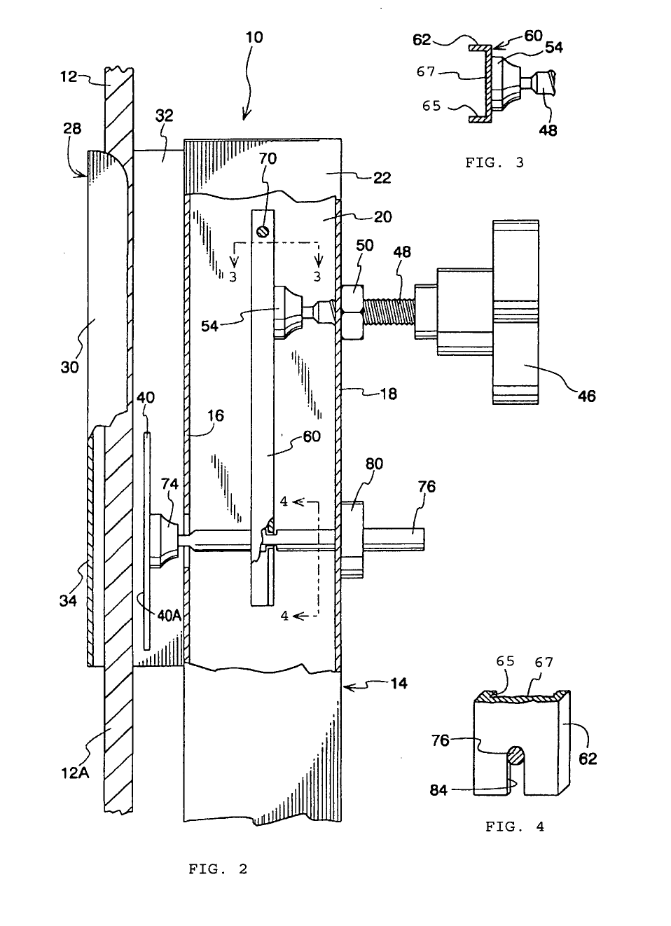

Referring to FIGS. 2-4, the releasable coupling assembly 10 includes a manually graspable knob 46 carried on a threaded shaft 48. Shaft 48 threadingly engages body 14. In the preferred embodiment, a threaded nut fastener 50 is secured to body wall 18 with a welded joinder. Other conventional types of engagement between shaft 48 and body 14 can also be employed. Threaded shaft 48 of the preferred embodiment carries a swivel-mounted pad 54 at its free end, with the forward face of pad 54 contacting a channel-shaped lever arm 60. Referring briefly to FIG. 3, lever arm 60 has a V-cross-sectional shape with sidewalls 62, 65 and an intermediate wall 67 contacted by pad 54. Pad 54 is connected by a conventional ball and socket arrangement (not shown) with threaded shaft 48.

Referring again to FIG. 2, lever arm 60 is pivotally mounted at its upper end to the sidewalls 20, 22 of body 14. Preferably, a pivot pin 70 extends through the upper arm of lever arm 60 to provide the pivotal mounting with opposed walls 20, 22. In the preferred embodiment, press plate 40 is fixedly joined to a mounting pad 74 which is swivel mounted (with a conventional ball and socket arrangement, not shown) to mounting shaft 76. The forward end of mounting shaft 76 is, as mentioned, swivel coupled to press plate 40. As can be seen in FIG. 2, the opposed rearward end of mounting shaft 76 is slidably supported in a conventional journal member 80. The journal member preferably has a mounting portion in the shape of a conventional washer which is secured to wall 18 of body 14 by welding or the like conventional attachment means. As shown in FIG. 2, the lower end of lever arm 60 is linked to mounting shaft 76 so that, as the lever arm 60 is pivotally swung toward the mast, press plate 40 will in turn be advanced toward the mast, for pressing engagement therewith. As shown in the cut-away portion toward the bottom of FIG. 2, lever arm 60 and mounting shaft 76 are coupled together by inter-connected notched portions such that the lever arm and mounting shaft 76 are captively engaged one with another. As shown in FIG. 4, the lower end of lever arm 60 is slotted at 84 so as to receive a reduced cross-sectional portion of mounting shaft 76. In the preferred embodiment, pad 54 is permanently joined to lever arm wall 67 by welding or other securement. Thus, as knob 46 is turned so as to extract threaded shaft 48 from the interior of body 14, the upper end of lever arm 60 is moved toward body wall 18, that is, in a rearward direction away from mast 12. Due to the coupling of lever arm 60 and mounting shaft 76, mounting shaft 76 is moved in a rearward direction, causing press plate 40 to move away from mast 12. As shown in the figures, mounting pad 54 is fixedly engaged with lever arm 60 and the lever arm is inter-locked with the mounting shaft 76. If desired, as an alternative, the rearward movement of press plate 40 could be made to be a permissible rather than a positive operation. For example, pad 54 would not be joined to lever arm 60 and the recessed portion of mounting shaft 76 could be elongated along the axis of the mounting shaft so as to allow a freedom of movement of press plate 40. When clamping pressure is desired, knob 46 is rotated in a direction so as to move threaded shaft 48 within the interior of body 14, causing lever arm 60 to move to the left, that is, toward mast 12. Since lever arm 60 is pivotally connected at its upper end, the bottom end of the lever arm is also moved to the left, bringing press plate 40 into engagement with mast 12. Eventually, mast 12 is compressed between press plate 40 and channel wall 34. As mentioned, it has been found important that the wall 34 be made stationary with respect to press plate 40 and that the clamping action be applied to mast 12 in the manner shown so as to avoid mechanical degradation of the mast. As can be seen in FIG. 2, the force applying operator (herein comprised of knob 46, threaded shaft 48 and swivel-mounted pad 54) is located along lever arm 60 so as to be closer to pivotal mounting 70 than the interconnection with mounting shaft 76. As a result, the mechanical advantage which can be applied to the lever arm is limited in a carefully defined manner controlled by the manufacturer. The amount of torque which can be applied to knob 46 by a human operator's manual grasp can be determined empirically or perhaps by reference to previous studies. By carefully selecting the thread pitch of shaft 48 and the attachment position of mounting pad 54 along lever arm 60, the maximum compression applied to the mast member can be reliably defined, i.e., limited by the manufacturer of the coupling assembly. In the preferred embodiment illustrated in the figures, the length of press plate 40 is less than half the length of channel wall 34 contacted by mast 12, and the press plate is disposed adjacent one end of channel wall 34. These relative arrangements can be varied as desired to provide, for example, operation optimized for static conditions, or for vibrating conditions, or for a compromise operation yielding satisfactory performance results under both stationary and vibrational conditions.

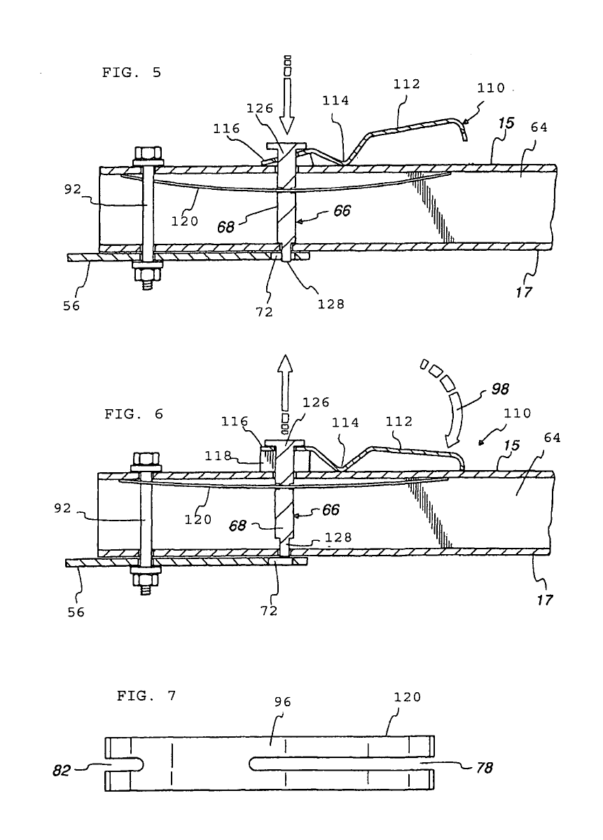

Referring now to FIGS. 5-7, actuator 110 forms part of a locking mechanism for moving locking tip or pin 128 between an extended or locking position illustrated in FIG. 5 and a retracted or unlocked position illustrated in FIG. 6. Locking pin 128 is preferably carried at the free end of a shoulder pin 66, and has a body 68 dimensioned larger than locking pin 128 and having an enlarged head 126. Pin 66 further includes an annular recess for receiving a bifurcated portion 96 of a leaf spring 120 shown in FIG. 7. As can be seen in FIG. 7, leaf spring 120 includes an elongated slot 78 which receives the annular depression of pin 66 thus, in the arrangements shown in FIGS. 5 and 6, leaf spring 120 is held captive with pin 66. In FIG. 5, spring 120 is in its relaxed position, urging locking pin 128 to the extended, locking position so as to protrude beyond the opposite surface 17 of leg 64. FIG. 6 shows leaf spring 120 in a depressed position storing spring force which, when allowed to release, urges pin 66 in a downward direction to assume the position illustrated in FIG. 5. In the unlocked or retracted configuration shown in FIG. 6, locking pin 128 is retracted beneath opposite surface 17 of leg 64.

Referring again to FIG. 7, leaf spring 120 includes a slotted free end 82 which, with reference to FIGS. 5 and 6, is held captive to the through-bolt fastener 92 which pivotably mounts leg 64 to ear 56 of support base 52 (shown in FIG. 1). In the arrangement illustrated, locking pin 128 is shown in alignment with a locking hole 72 which secures the leg in an upright storage position. With the locking pin 128 in the extended position illustrated in FIG. 5, leg 64 is locked in an upright position parallel to upright mast 12. With the locking pin 128 retracted as illustrated in FIG. 6, leg 64 is free to pivot about bolt 92, so as to bring locking pin 128 into alignment with the locking hole 68, thereby securing the leg in an open or extended position.

Referring again to FIGS. 5 and 6, with the spring 120 in a relaxed position indicated in FIG. 5, locking pin 128 protrudes beyond leg 64, while the shoulder portion of pin 66 engages the leg wall so as to prevent further extension of the locking pin, beyond its designed point. The enlarged head 126, with the remainder of pin 66, is biased in a downward direction under the force of spring 120, thereby causing rotation of actuator 110 in a counterclockwise direction about fulcrum portion 114, bringing pin engaging portion 116 toward leg 128. In the preferred embodiment, with pin 66 fully extended, further extension of the locking pin is prevented by engagement of the shoulder portion of pin 66 with leg 64.

The drawings and the foregoing descriptions are not intended to represent the only forms of the invention in regard to the details of its construction and manner of operation. Changes in form and in the proportion of parts, as well as substitution of equivalents, are contemplated as circumstances may suggest or render expedient; and although specific terms have been employed, they are intended in a generic and descriptive sense only and not for the purposes of limitation, the scope of the invention being delineated by the following claims.

1. A sign stand assembly, comprising:
a flat steel spring strip extending in a generally vertical direction and having top and bottom ends;
a releasable coupling assembly adapted for receiving an upright mast removably secured to the top portion of the spring strip;
a support base removably secured to the bottom portion of the spring strip;
at least one leg pivotally mounted to the support base;
a pin member adapted to selectively lock the leg in a collapsed or operational position.

2. A sign stand assembly according to claim 1 wherein the releasable coupling assembly adapted for receiving an upright mast comprises:
a mounting channel for receiving the upright mast;
a press plate movably mounted for movement toward and away from said channel for clamping said mast in said channel and releasing said mast from said channel respectively;
an operating member for applying force to said press plate; and
a lever arm coupling said operating member and said press plate to move said press plate toward and away from said channel.

3. The sign stand assembly of claim 2 wherein said lever arm is double ended and is pivotally mounted at one end, adjacent the operating member.

4. The sign stand assembly of claim 2 wherein said press plate is carried at one end of a mounting shaft.

5. The sign stand assembly of claim 2 wherein said press plate is pivotally mounted to the mounting shaft.

6. The sign stand assembly of claim 2 wherein said channel includes journal adapted to mount said mounting shaft.

7. The sign stand assembly of claim 2 wherein said lever arm is connected to said mounting shaft with a keyed interlock.

8. The sign stand assembly of claim 2 wherein said operating member comprises a manually engageable screw shaft thrcadingly engaging said channel.

9. The sign stand assembly of claim 2 further comprising a pad for engaging said lever arm, pivotally mounted at the end of said screw shaft.

10. The sign stand assembly of claim 2 wherein said lever arm has a generally C-shaped cross section.

11. The sign stand assembly according to claim 1 wherein the support base includes:
a plate portion defining a locking recess;
a plurality of legs, at least one leg having a wall defining a hollow interior of the leg;
pivotal connections pivotally connecting the legs to the plate portion;
a locking pin carried on said at least one leg, for movement toward and away from the locking recess defined by said at least one leg; and
an actuator having a first end portion within said at least one leg for engaging said locking pin, an opposed second end portion with an outwardly protruding tab at least partially overlying said plate portion and a medial portion extending through said wall and cooperating with said wall and said locking pin to maintain said actuator captively engaged with said leg.

12. The sign stand assembly of claim 11 wherein said locking pin extends through said at least one leg.

13. The sign stand assembly according to claim 11 wherein said actuator first end portion, second end portion and medial portion include generally flat plate bodies, with said medial portion joined by curved parts to said first and said second end portions.

14. The sign stand assembly of claim 11 wherein said locking pin has a generally cylindrical body with a second end portion of predetermined size remote from said plate portion and an opposed first end portion of reduced size adjacent said plate portion, with a stepped shoulder between said first and said second end portions.

15. The sign stand assembly according to claim 14 wherein the second end portion defines a spring-receiving recess and said sign stand assembly further comprises a flat spring with a first end having a clevis portion at least partly slidably received in said spring-receiving recess, said spring urging said tab away from said wall of said at least one leg.

16. The sign stand assembly according to claim 15 wherein the flat spring includes a second end having a clevis portion engaging the pivotal connection of said at least one leg.

17. The sign stand assembly according to claim 11 wherein said tab extends toward the pivotal connection of said at least one leg.

18. The sign stand assembly according to claim 14 wherein said first end portion of said actuator includes a clevis portion receiving at least a part of the first end portion of said locking pin and dimensioned for interfering contact with the stepped shoulder of said locking pin to transfer an actuating force to said locking pin to move said locking pin away from said locking recess.

19. The sign stand assembly according to claim 16 wherein the pivotal connection of said at least one leg comprises a bolt fastener extending through said plate portion and said at least one leg.

20. A sign stand assembly, comprising:
a flat steel spring strip extending in a generally vertical direction and having top and bottom ends;
a releasable coupling assembly adapted for receiving an upright mast secured to the top portion of the spring strip;
a support base secured to the bottom portion of the spring strip, said support base including an L-shaped vertical mounting piece supported between side plates wherein the side plates include at least one ear portion defining at least one hole, said hole defining a locking recess; and
at least one leg having a locking pin, for movement toward and away from the locking recess in the at least one ear portion, pivotally mounted to the at least one car portion of the support base.
